(19) United States
(12) Patent Application Publication
(10) Pub. No.: US 2012/0234930 A1
(43) Pub. Date: Sep. 20, 2012

(54) AUTOMATIC REMOTE START/STOP CONTROL STRATEGY FOR VEHICLE HEATING AND COOLING SYSTEMS

(75) Inventor: Halim Wijaya, Canton, MI (US)

(73) Assignee: FORD GLOBAL TECHNOLOGIES, LLC, Dearborn, MI (US)

(21) Appl. No.: 13/049,980

(22) Filed: Mar. 17, 2011

(51) Int. Cl. G05D 23/02; G05B 19/045; F02N 11/08

(52) U.S. Cl. 236/51; 123/179.2

(57) ABSTRACT

A system and method for preconditioning a vehicle interior via a remote start device based on then-current weather conditions independent of the previous climate control head settings in place at the termination of the vehicle's last use are disclosed. The preconditioning system and method may be used in either electronic automatic temperature control (EATC) systems or in manual temperature control (MTC) systems. When used in conjunction with an EATC system, variables including sunload, Tset point (that is, the temperature door position), Tambient, and Tcabin are used to calculate the climate load demand. When used in conjunction with an MTC system, Tambient, Tset point, and Tcabin are used to calculate the climate load demand. In the event that the MTC system does not have a Tcabin sensor then Tevaporator thermister is used to calculate the climate load demand in the beginning of the remote start. The disclosed system and method also has windshield defrosting/defog and rear glass defrost capabilities. The disclosed control strategies are also capable of turning on/off the heated/cooled seats (when present) and the heated steering wheel (when present) according to the cabin thermal comfort conditions.

### TECHNICAL FIELD

The disclosed invention relates generally to a system for remote start systems for vehicles. More particularly, the disclosed invention relates to a remote start system for a vehicle which enables the vehicle cabin to achieve an optimum cabin thermal comfort level based on contemporary ambient weather conditions instead of previous climate control settings.

### BACKGROUND OF THE INVENTION

A relatively new innovation in the automotive vehicle is the remote start device. The remote start device enables a user to start the vehicle without actually being in the vehicle. The device is incorporated into the vehicles electrical system and responds to a signal from a user-operated remote signal transmitter. By using the remote start device the user-operator can start the vehicle in advance of actual use. By remote starting the vehicle, the car can warm up or to cool down for use as may be required and to allow the cabin to be pre-conditioned to a desired cabin condition prior to the occupants actually entering the vehicle cabin.

While representing an improvement in vehicle operation, known remote start devices simply start the automotive vehicle without allowing for changes in ambient condition from the last drive. Particularly, by merely starting the vehicle the known remote start devices essentially have the vehicle default to the last-known climate control setting of the vehicle as set from the previous drive. However, since the last drive climate conditions may have changed such that the default settings are no longer correct. In addition, there is always the possibility that the climate control system was left in the “off” position at the end of the previous drive. In such situations upon entry into the vehicle the occupants would find that the cabin thermal comfort conditions are not satisfactory, thus requiring a change in settings and time necessary for the changes to take effect. This circumstance negates many of the advantages of the remote start device.

Accordingly, as is often the case, there is room for improvement in the art of remote start control devices for vehicles to achieve maximum passenger cabin comfort for the vehicle occupants prior to their entering the vehicle cabin.

### SUMMARY OF THE INVENTION

The disclosed invention provides a method of preconditioning a vehicle interior via a remote start independent of the previous climate control head settings in place at the termination of the vehicle's last use. Particularly, the disclosed auto remote start control strategy enables the conditioning of the vehicle cabin automatically based upon any then-existing ambient weather condition. As a result, the users will achieve an optimum cabin thermal comfort at any time regardless of the weather or the previous climate control head settings.

The disclosed system has utility in both electronic automatic temperature control (EATC) systems as well as in manual temperature control (MTC) systems. When used in conjunction with an EATC system, variables including sunload, Tset point (that is, the temperature door position), Tambient, and Tcabin are used to calculate the climate load demand. When used in conjunction with an MTC system, Tambient, Tset point, and Tcabin are used to calculate the climate load demand. In the event that the MTC system does not have a Tcabin sensor then Tevaporator thermister is used to calculate the climate load demand in the beginning of the remote start.

Regardless of the system, once climate load demand is calculated then the control head air delivery mode position, the temperature door, the blower speed and the air inlet position are specified. In the EATC control head these positions will change in real time as the cabin condition changes. In the MTC control head (which does not have the Tcabin sensor), these positions will remain the same during the remote start period.

In addition to providing the optimum cabin thermal comfort, the disclosed control strategy provides windshield defrosting/defog and rear glass defrost capabilities. The disclosed control strategies are also capable of turning on/off the heated/cooled seats (when present) and the heated steering wheel (when present) according to the cabin thermal comfort conditions.

Once users enter the vehicle, the remote start strategy is terminated and the control head resets to the user's previous settings.

The disclosed control strategies provide several advantages over known auto start systems. The disclosed system can provide optimum cabin comfort regardless of weather conditions. In addition, the disclosed system prevents overcooling/overheating issues also regardless of the weather conditions. Furthermore, the disclosed climate control strategy does not only depend on the Tambient but incorporates cabin thermal comfort when the auto remote start is initiated.

Other advantages and features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawing and described below by way of examples of the invention wherein:

FIG. 1 is a block diagram illustrating a remote start strategy for an electronic automatic temperature control system;

FIG. 2 is a flow chart illustrating a remote start strategy for an electronic automatic temperature control system according to a first embodiment of the disclosed invention;

FIG. 3 is a flow chart illustrating a remote start strategy for an electronic automatic temperature control system according to a second embodiment of the disclosed invention;

FIG. 4 is a block diagram illustrating a remote start strategy for a manual control head temperature control system;

FIG. 5 is a flow chart illustrating a remote start strategy for a manual control head without partial recirculation; and

FIG. 6 is a flow chart illustrating a remote start strategy for a manual control head with partial (automatic) recirculation.

### DETAILED DESCRIPTION OF THE PREFERRED EMBODIMENT

In the following description, various operating parameters and components are described for different constructed embodiments. These specific parameters and components are included as examples and are not meant to be limiting.

In general, the system and method for preconditioning a vehicle interior by way of a remote starting device independent of the previous climate control head settings in place at the termination of the vehicle's last use is discussed in detail hereinafter. The disclosed auto remote start control strategy enables the conditioning of the vehicle cabin automatically based upon any then-existing ambient weather condition. According to the disclosed system and method for preconditioning a vehicle, users will achieve an optimum cabin thermal comfort after a certain time regardless of the weather or the previous climate control head settings.

The system of the disclosed invention may be used with either an electronic automatic temperature control (EATC) arrangement or with a manual temperature control (MTC) arrangement, either with or without partial recirculation.

The disclosed system for preconditioning a vehicle interior independent of previous climate control settings includes a remote starting device and a climate control head operatively associated with the remote starting device. The control head includes a control logic for determining and for responding to climate load demand. The system further includes a temperature control door operatively associated with the control head and a plurality of sensors. These sensors can include without limitation an ambient temperature sensor (Tamb), an interior temperature sensor (Tcabin or Tevaporator thermister if there is no Tcabin sensor), a temperature door sensor (Tset point), and, in the case of use with an EATC, a sunload sensor.

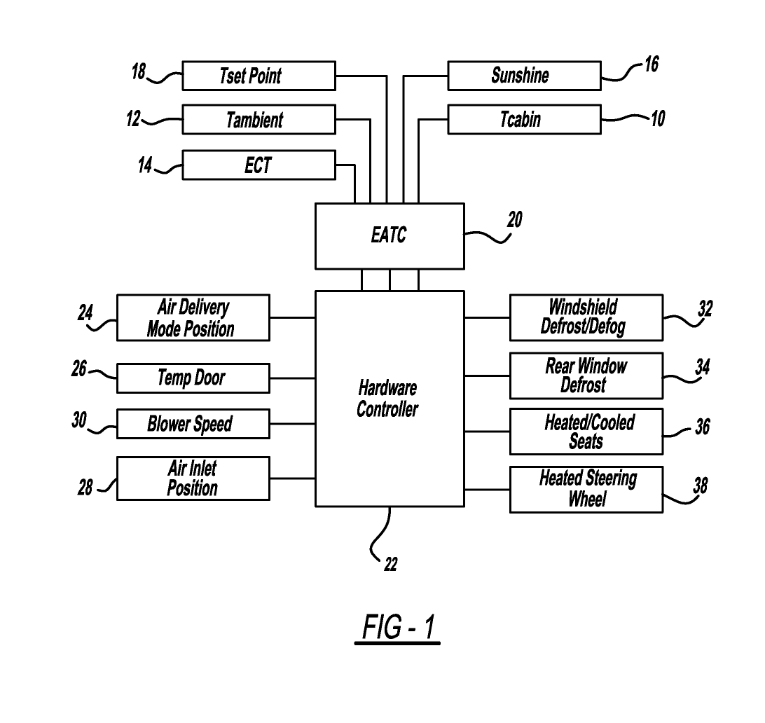

Particularly, and with reference to FIG. 1, a block diagram illustrating a representative remote start strategy for an electronic automatic temperature control (EATC) system is shown. The system includes various sensors that provide signals representative of vehicle cabin temperature (Tcabin) 10, ambient (outside) air temperature (Tambient) 12, engine coolant temperature (ECT) 14, and sunload 16. In addition, an occupant interface allows the occupant to provide a desired temperature or temperature range (Tset Point) 18. The sensor and interface signals are provided to the electronic automatic temperature control (EATC) 20. The EATC 20 calculates Climate Load Demand as set forth below and provides instructive output signals to a hardware controller 22 based upon these calculations. Once climate load demand is calculated and fed to the hardware controller 22, the controller 22 specifies the positions of the air delivery mode 24, the temperature door 26 and the air inlet 28 while also determining the speed of the blower 30. In the EATC 20 these positions will change in real time as the cabin condition changes. The hardware controller 22 also outputs instructions to a windshield defroster/defogger 32, a rear window defroster 34, and, if fitted, heated/cooled seats 36 and a heated steering wheel 38.

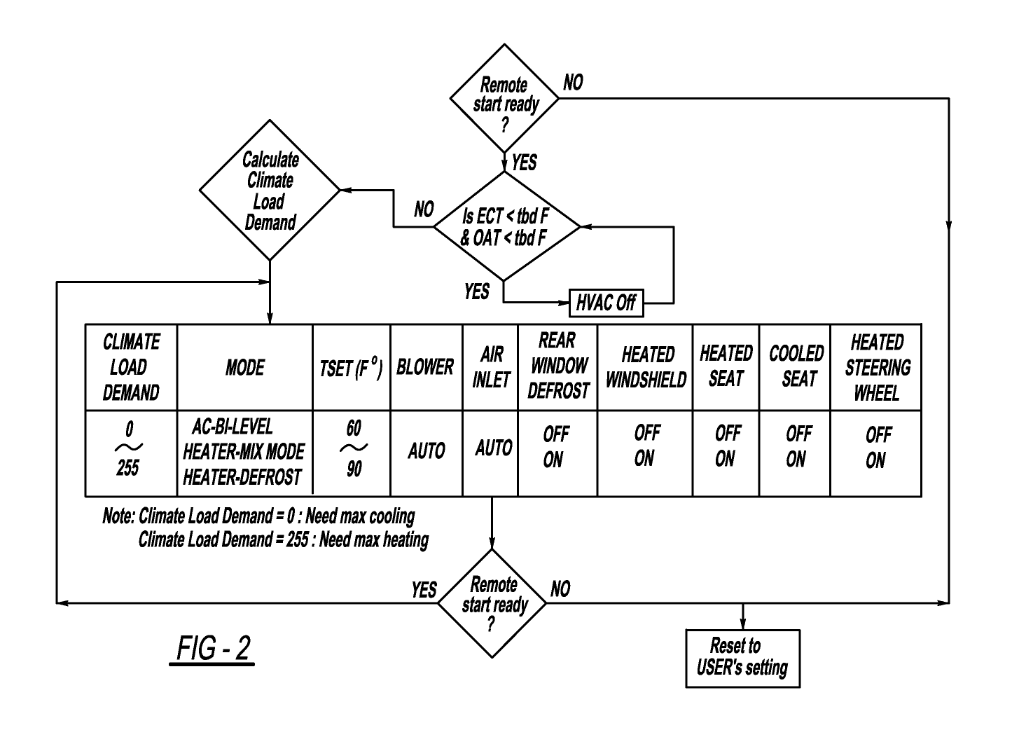

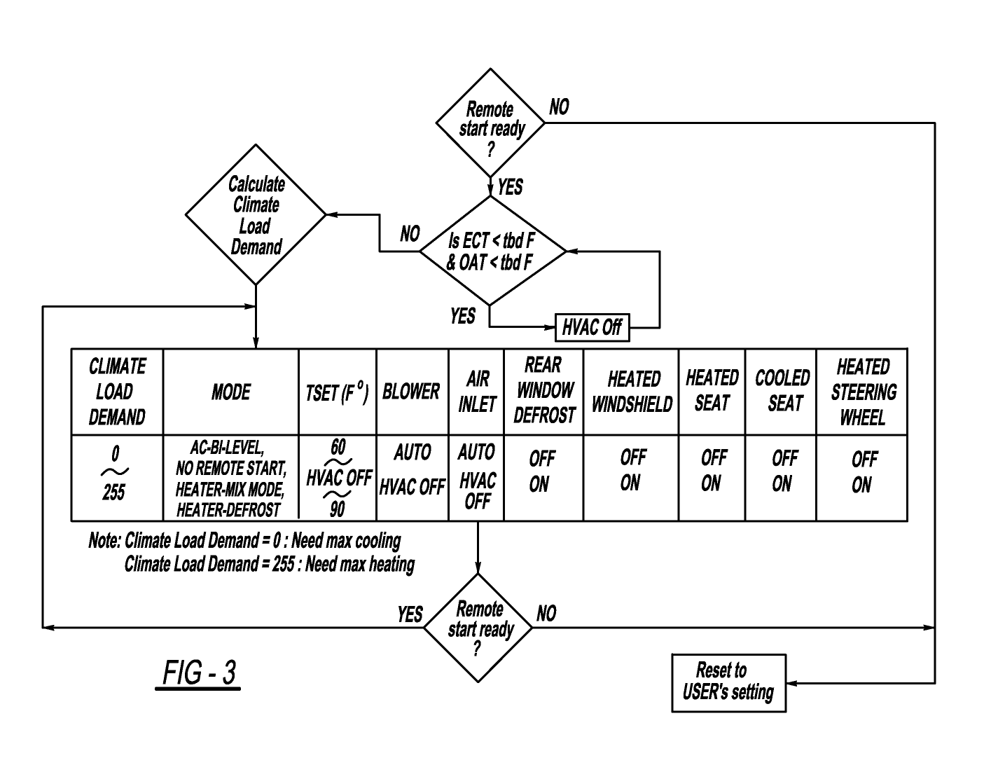

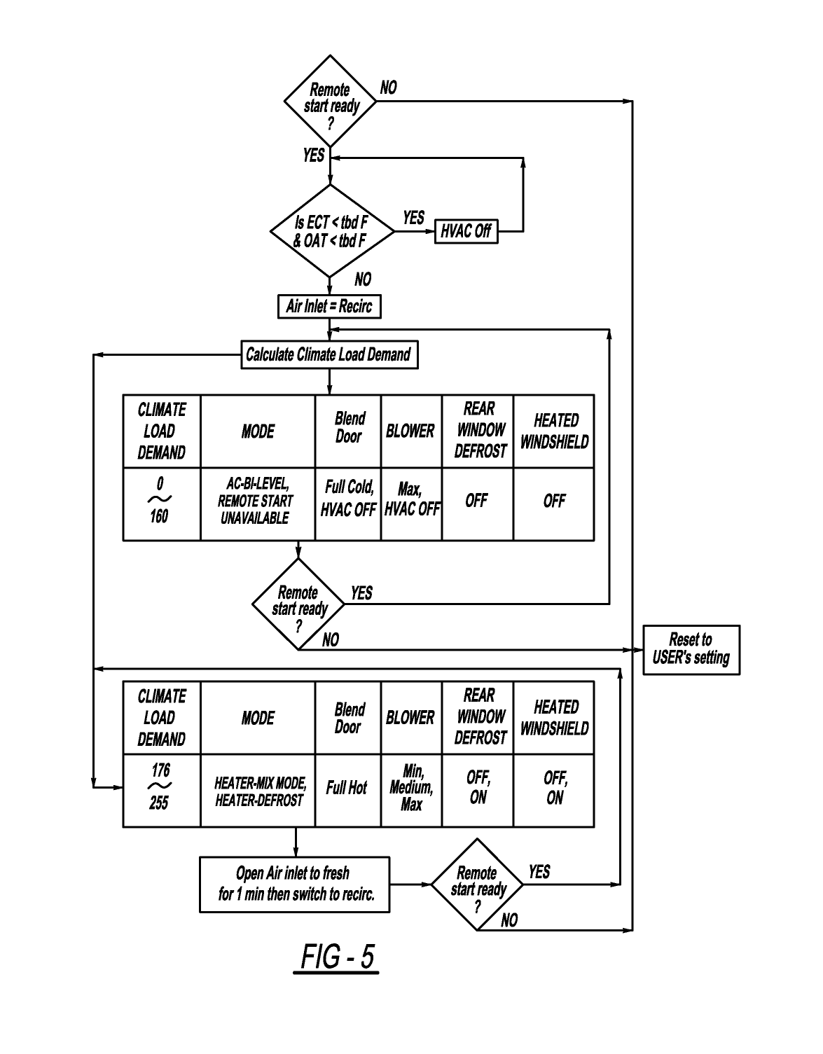

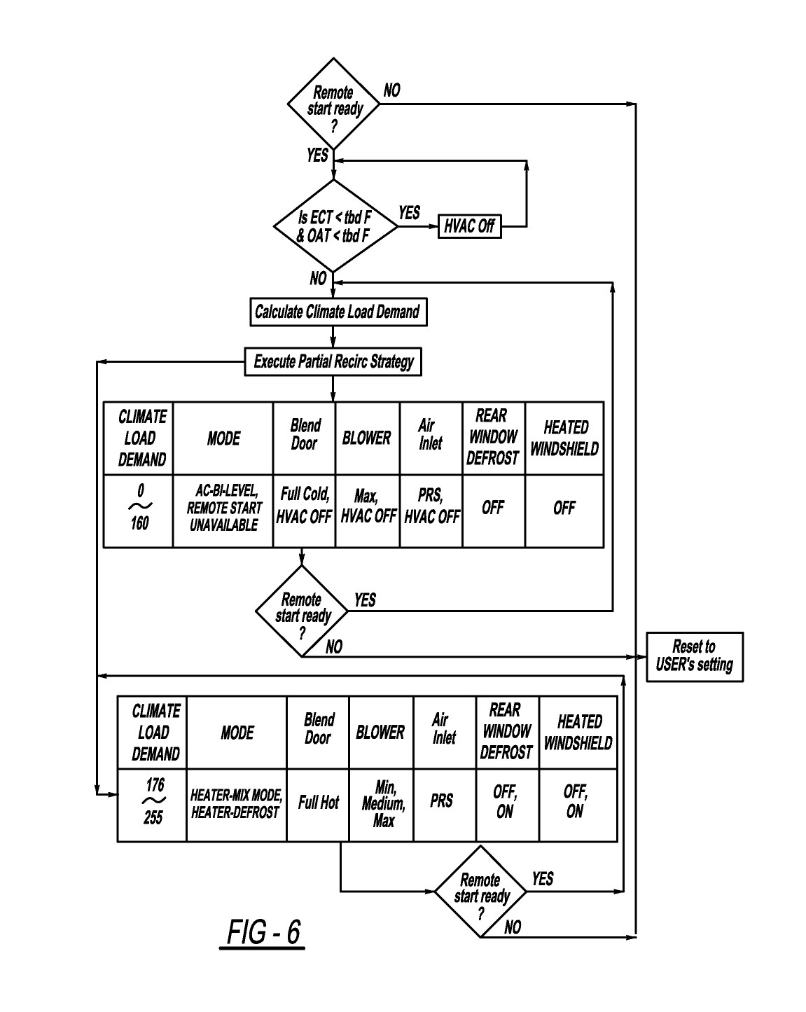

FIGS. 2 and 3 relate to control logic as used with an EATC. FIGS. 5 and 6 relate to control logic as used with an MTC.

With reference to FIGS. 2 and 3, when the disclosed system is used with an EATC system, preferred variables including sunload, Tset point, Tambient, and Tcabin are used to calculate the climate load demand. Two alternative control logic methodologies are set forth herein, although it is to be understood that variations on the disclosed methodologies are possible as are alternate control logic arrangements. Accordingly the disclosed two control logic methodologies are set forth as examples and are not intended as being limiting.

With respect first to FIG. 2, a flow chart illustrating a first remote start strategy for an electronic automatic temperature control system according to an embodiment of the disclosed invention is set forth. According to the illustrated flow chart, an initial inquiry is made as to the status of the Remote Start. If the Remote Start is not ready, the system is reset to the user/operator's original settings for a re-attempt. If the Remote Start is ready, the system inquires as to the status of the ECT (engine coolant temperature) and the OAT (outside ambient temperature). If it is found that both values are below a to-be-determined temperature then the HVAC system is turned off and the inquiry is made again.

If it is determined that the ECT and OAT values are greater than a predetermined temperature, a Climate Load Demand calculation is performed. The calculation is based on the following: C1−C2 (sunload)+C3 (Tset Point−T-set baseline)+C4 (Tset baseline−Tamb) +C5 (Tset Point−Tincar). Based on the value of the calculated Climate Load Demand of from 0 (requiring maximum cooling) to 255 (requiring maximum heating), the climate control mode (AC versus heater and level selection [bi-level, mix mode, defrost], the Tset (represented in the figures in Fahrenheit), the blower mode, the air inlet mode, the rear window defrost mode, the heated windshield mode, the heated/cooled seat modes, and the heated steering wheel mode are all determined and are adjusted accordingly.

Further with respect to FIG. 2, the Climate Load Demand range of between 0 and 255 is set forth for illustrative purposes only and is not intended as being limiting. Depending on Climate Load Demand, the mode may be one of AC-Bi-Level, Automatic, Heater—Mix Mode, and Heater—Defrost. The Tset ranges between 60 and 90 (F°), also illustrating a possible but not an exclusive range. Both the Blower and the Air Inlet are preferably set in Automatic mode. The heated or cooled components, including the Rear Window Defrost, the Heated Windshield, the Heated Seat, the Cooled Seat, and the Heated Steering Wheel, may be either On or Off, depending on Climate Load Demand. This list is intended as being suggestive and not limiting.

Sample settings are as follows. If the Climate Load Demand is 0, the Mode may be set at AC-Bi-Level, the Tset may be 60 F°, the Blower and Air Inlet set on Auto, and the Rear Window Defrost, the Heated Windshield, the Heated Seat, and the Heated Steering Wheel all set on Off. Only the Cooled Seat is set to On.

If the Climate Load Demand is 96, the Mode may be set on Auto, the Tset may be 72 F°, and the Blower and Air Inlet are set on Auto. The Rear Window Defrost, the Heated Windshield, the Heated Seat, the Cooled Seat, and the Heated Steering Wheel are all set in Off position.

On the other hand, if the Climate Load Demand is 208, the Mode may be set at Heater-Mix Mode, the Tset may be set at 90 F°, the Blower and Air Inlet may be set on Auto, and each of the Rear Window Defrost, the Heated Windshield, the Heated Seat, and the Heated Steering Wheel would be set in the On position. Only the Cooled Seat would be set in the Off position.

As a further example, if the Climate Load Demand is 255, the Mode is set at Heater-Defrost, the Tset may be set at 90 F°, and the Blower and Air Inlet may be set in the Auto position. As with the example above, each of the Rear Window Defrost, the Heated Windshield, the Heated Seat, and the Heated Steering Wheel would be set in the On position while the Cooled Seat would be set in the Off position.

The above-described logic is only exemplary and it is to be understood that many variations may be made without deviating from the invention as disclosed and described. For example, the Climate Load Demand values can be modified as required.

By way of further example, and with reference to FIG. 3, the control logic for use with the EATC may include a defined and limited Climate Load Demand range in which no remote start is available. This is so because the range defines a comfort zone of approximately 65° F. to 72° F. and in such a range the HVAC system is ordinarily off and thus no remote start to precondition the vehicle cabin is necessary.

In addition, in FIG. 3 the Climate Load Demand range of between 0 and 255 is set forth for illustrative purposes only and is not intended as being limiting. Depending on Climate Load Demand, the mode may be one of AC-Bi-Level, No Remote Start, Heater—Mix Mode, and Heater—Defrost. In addition, it is possible that none of these is available The Tset ranges between 60 and 90 (F°), also illustrating a possible but not an exclusive range. In a portion of this range, for example, a Climate Load Demand of between 48 and 160, the HVAC system would be Off. Both the Blower and the Air Inlet are preferably set in Automatic mode, unless the HVAC system is Off. The heated or cooled components, including the Rear Window Defrost, the Heated Windshield, the Heated Seat, the Cooled Seat, and the Heated Steering Wheel, may be either On or Off, depending on Climate Load Demand. This list is intended as being suggestive and not limiting.

Sample settings are as follows. If the Climate Load Demand is 0, the Mode may be set at AC-Bi-Level, the Tset may be 60 F°, the Blower and Air Inlet set on Auto, and the Rear Window Defrost, the Heated Windshield, the Heated Seat, and the Heated Steering Wheel all set on Off. Only the Cooled Seat is set to On.

If, on the other hand, the Climate Load Demand is 48, then Remote Start would be unavailable, and the Tset, the Blower and the Air Inlet are not involved as the HVAC would be Off. Each of the Rear Window Defrost, the Heated Windshield, the Heated Seat, and the Heated Steering Wheel would be set in the Off position. Only the Cooled Seat would be set in the On position.

As another non-limiting example, if the Climate Load Demand is 160, again Remote Start would be unavailable, and the Tset, the Blower and the Air Inlet are not involved as the HVAC would be Off. Each of the Rear Window Defrost, the Heated Windshield, the Heated Seat, the Heated Steering Wheel, and the Cooled Seat would be set in the Off position.

If the Climate Load Demand is 208, the Mode may be seat at Heater-Mix Mode, the Tset may be set at 90 F°, the Blower and Air Inlet may be set on Auto. Each of the Rear Window Defrost, the Heated Windshield, the Heated Seat, and the Heated Steering Wheel would be set in the On position. Only the Cooled Seat would be set in the Off position.

As an additional example, if the Climate Load Demand is 255, the Mode is set at Heater-Defrost, the Tset may again be set at 90 F°, and the Blower and Air Inlet may be set in the Auto position. As with the example above, each of the Rear Window Defrost, the Heated Windshield, the Heated Seat, and the Heated Steering Wheel would be set in the On position while the Cooled Seat would be set in the Off position.

The scenarios set forth above with respect to FIGS. 2 and 3 are intended as being illustrative and are not intended as being limiting. It is envisioned that other variations of the control logic when used with the EATC are possible.

It will not always be the case that the vehicle having a remote start system disclosed in the present invention will have an EATC but instead will be equipped with the above-noted manual temperature control (MTC) system. This system of necessity requires a different control logic from the one described above associated with the EATC. This is discussed below in relation to FIGS. 5 and 6.

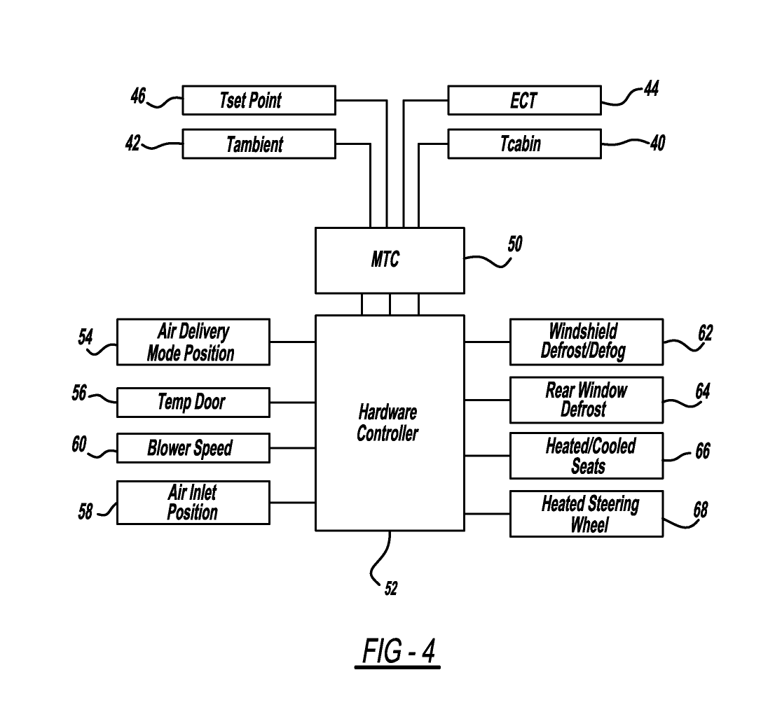

With reference to FIG. 4, a block diagram illustrating a representative remote start strategy for a manual temperature control (MTC) system is shown. The system includes various sensors that provide signals representative of vehicle cabin temperature (Tcabin) 40, ambient (outside) air temperature (Tambient) 42, and engine coolant temperature (ECT) 44. (If a Tcabin is not provided then Tevaporator thermister is used to calculate Climate Load Demand in the beginning of the remote start.) An occupant interface allows the occupant to provide a desired temperature or temperature range (Tset Point) 46. The sensor and interface signals are provided to the manual temperature control (MTC) 50. The MTC 50 calculates climate load demand as set forth below and provides instructive output signals to a hardware controller 52 based upon these calculations. Once climate load demand is calculated and fed to the hardware controller 52, the controller 52 specifies the positions of the air delivery mode 54, the temperature door 56 and the air inlet 58 while also determining the speed of the blower 60. Where the MTC 50 lacks the Tcabin sensor these positions will stay the same during the remote start period. The hardware controller 52 also outputs instructions to a windshield defroster/defogger 62, a rear window defroster 64, and, if fitted, heated/cooled seats 66 and a heated steering wheel 68.

The control logic for use with the MTC is set forth in two variations, one in FIG. 5 and the other in FIG. 6. Both control logics function in conjunction with a manual control head. The first, that set forth in FIG. 5, functions without a partial recirculation strategy, while the second, that set forth in FIG. 6, functions using a partial recirculation strategy.

With reference first to FIG. 5, a control logic is illustrated in which an initial inquiry is made as to the status of the Remote Start. If the Remote Start is not ready, the system is reset to the user/operator's original settings for a re-attempt. If the Remote Start is ready, the system inquires as to the status of the ECT (engine coolant temperature) and the OAT (outside ambient temperature). If it is found that both values are below a to-be-determined temperature then the HVAC system is turned off and the inquiry is made again.

If it is determined that the ECT and OAT values are greater than a predetermined temperature, the air inlet is set to recirculation and a Climate Load Demand calculation is performed. The calculation is based on the following: Z1−Z2 (Tset Point−Tset baseline)+Z3 (Tset baseline−Tamb)+Z4 (Tset Point−Tincar). The preferred relationship between the temperature door vs. Tset Point is as follows:

TABLE 1
Temperature Door vs. Tset Point
0% = 60° F.
20% = 65° F.
40% = 72° F.
60% = 78° F.
80% = 85° F.
100% = 90° F.

For cooling the vehicle interior the Climate Load Demand calculation is done once prior to the vehicle compressor being turned on. (Once the compressor is on, then Tevap thermister would not generate the same value as Tcabin.) On the other hand, for heating the vehicle interior the Climate Load Demand calculation is made once based on Tevap thermister being the same as Tcabin. During heating the open air inlet door is switched to fresh air periodically at a preferred interval (for example, 3 minutes) for a period (such as one minute) to prevent glass fogging.

In FIG. 5 the Climate Load Demand range of between 0 and 160 and between 176 and 255 are set forth for illustrative purposes only and are not intended as being limiting. Depending on Climate Load Demand, the mode may be one of AC-Bi-Level, Heater—Mix Mode, and Heater—Defrost. In addition, it is possible that none of these is available in a certain range of the Climate Load Demand. For example, at a given range of Climate Load Demand, perhaps between 48 and 160, no Remote Start would be needed and thus the HVAC system would be Off.

The Blend Door may be set at Full Cold or Full Hot depending on Climate Load Demand depending on Climate Load Demand. Within the range where no Remote Start is available the HVAC system would be Off. Also depending on Climate Load Demand the Blower could run at Max(imum), Min(imum), or Medium speeds or, again in the case of a certain Climate Load Demand, would not be engaged at all because the HVAC system would be Off. The Rear Window Defrost and the Heated Windshield can be either Off or On depending on the Climate Load Demand Setting.

The control logic of FIG. 5 for use with the MTC may include a defined and limited Climate Load Demand range (in this instance, 80 through 160, although the range value can be any selected range) in which no remote start is available. This is so because the range defines a comfort zone in which the HVAC system is ordinarily off and thus no remote start to precondition the vehicle cabin is necessary.

Sample settings are as follows. If the Climate Load Demand is 0, the Mode may be set at AC-Bi-Level, the Blend Door may be set at Full Cold and the Blower at Max(imum). Both the Rear Window Defrost and the Heated Windshield are Off.

If the Climate Load Demand is, for example, at 64, the Mode may be set at AC-Bi-Level, the Blend Door may be set at Full Cold and the Blower at Max(imum). Both the Rear Window Defrost and the Heated Windshield again are Off.

If, on the other hand, the Climate Load Demand is between, again for example, 80 and 160, then there will be No Remote Start available since there will be no need to modify the cabin environment given ambient conditions being within the comfort range. In such a situation the Blend Door and the Blower are not involved as the HVAC would be Off. Both the Rear Window Defrost and the Heated Windshield would be Off.

As another non-limiting example, if the Climate Load Demand is at, for example, 176, the Mode may be set at Heater-Mix Mode, the Blend Door may be set at Full Hot and the Blower may be set at Min(imum). The Rear Window Defrost and the Heated Windshield may be Off.

As an additional non-limiting example, if the Climate Load Demand is at, for example, 208, the Mode may be set at Heater-Mix Mode, the Blend Door may be set at Full Hot and the Blower may be set at Med(ium). The Rear Window Defrost and the Heated Windshield would be On.

In the event that the Climate Load Demand is at, for example, 255, the Mode may be set at Heater-Defrost, the Blend Door may be set at Full Hot and the Blower may be set at Max(imum). Both the Rear Window Defrost and the Heated Windshield would be On.

As noted above, it may be that the manual temperature control system uses a partial air recirculation strategy. If that is the case then the control logic is somewhat different than that described above and shown in FIG. 5. The control logic used in a vehicle equipped with partial recirculation strategy is set forth in FIG. 6. In such a system Tincar is available and is used to calculate Climate Load Demand in real time.

With reference to FIG. 6, a control logic is illustrated in which an initial inquiry is made as to the status of the Remote Start. If the Remote Start is not ready, the system is reset to the user/operator's original settings for a re-attempt. If the Remote Start is ready, the system inquires as to the status of the ECT (engine coolant temperature) and the OAT (outside ambient temperature). If it is found that both values are below a to-be-determined temperature then the HVAC system is turned off and the inquiry is made again.

If it is determined that the ECT and OAT values are greater than a predetermined temperature, a Climate Load Demand calculation is performed. As in the case of the control logic of FIG. 5, the calculation of the Climate Load Demand of FIG. 6 is based on the following: Z1−Z2 (Tset Point−Tset baseline)+Z3 (Tset baseline−Tamb)+Z4 (Tset Point−Tincar). The preferred relationship between the temperature door vs. Tset Point is as set forth above in Table 1.

Once the Climate Load Demand is calculated the partial recirculation strategy is undertaken automatically so that the blend door is opened and closed based on humidity in the cabin. The partial recirculation strategy (PRS) is the subject of co-pending U.S. patent application Ser. No. 12/831,380, filed Jul. 7, 2010, for “Partial Air Inlet Control Strategy for Air Conditioning System,” assigned to the same assignee of the instant patent application, and incorporated herein by reference.

The Climate Load Demand range of between 0 and 160 and between 176 and 255 of FIG. 6 are set forth for illustrative purposes only and are not intended as being limiting. Depending on Climate Load Demand, the mode may be one of AC-Bi-Level, Heater—Mix Mode, and Heater—Defrost. In addition, it is possible that none of these is available in a certain range of the Climate Load Demand. For example, at a given range of Climate Load Demand, perhaps between 48 and 160, no Remote Start would be needed and thus the HVAC system would be Off.

The Blend Door may be set at Full Cold or Full Hot depending on Climate Load Demand depending on Climate Load Demand. Within the range where no Remote Start is available the HVAC system would be Off. Also depending on Climate Load Demand the Blower could run at Max(imum), Min(imum), or Medium speeds or, again in the case of a certain Climate Load Demand, would not be engaged at all if the HVAC system was Off. The Air Inlet setting is at PRS although it would be inactive where the HVAC system is Off at certain Climate Load Demand settings. The Rear Window Defrost and the Heated Windshield can be either Off or On depending on the Climate Load Demand Setting.

The control logic of FIG. 6 for use with the MTC may include a defined and limited Climate Load Demand range (in this instance, 80 through 160, although the range value can be any selected range) in which no remote start is available. This is so because the range defines a comfort zone in which the HVAC system is ordinarily off and thus no remote start to precondition the vehicle cabin is necessary.

Sample settings are as follows. If the Climate Load Demand is 0, the Mode may be set at AC-Bi-Level, the Blend Door may be set at Full Cold, the Blower at Max(imum), and the Air Inlet at PRS. Both the Rear Window Defrost and the Heated Windshield are Off.

On the other hand, if the Climate Load Demand is, for example, at 64, the Mode may be set at AC-Bi-Level, the Blend Door may be set at Full Cold, the Blower at Max(imum), and the Air Inlet at PRS. Both the Rear Window Defrost and the Heated Windshield again are Off.

If the Climate Load Demand is between, again for example, 80 and 160, then there will be No Remote Start available since there will be no need to modify the cabin environment given ambient conditions being within the comfort range. In such a situation the Blend Door, the Blower and the Air Inlet are not involved as the HVAC would be Off. Both the Rear Window Defrost and the Heated Windshield would be Off.

By way of a further non-limiting example, if the Climate Load Demand is at, for example, 176, the Mode may be set at Heater-Mix Mode, the Blend Door may be set at Full Hot, the Blower may be set at Min(imum), and the Air Inlet may be set at PRS. The Rear Window Defrost and the Heated Windshield may be Off.

Additionally, if the Climate Load Demand is at, for example, 208, the Mode may be set at Heater-Mix Mode, the Blend Door may be set at Full Hot, the Blower may be set at Med(ium), and the Air Inlet may be set at PRS. The Rear Window Defrost and the Heated Windshield would be On.

In the event that the Climate Load Demand is at, for example, 255, the Mode may be set at Heater-Defrost, the Blend Door may be set at Full Hot, the Blower may be set at Max(imum), and the Air Inlet may be set at PRS. Both the Rear Window Defrost and the Heated Windshield would be On.

The above-described control logics are only exemplary and it is to be understood that many variations may be made without deviating from the invention as disclosed and described. For example, the Climate Load Demand values can be modified as required.

In addition, the control logic set forth above generally represents control logic for the described embodiments of a system or method according to the disclosed invention. As will be appreciated by one of ordinary skill in the art, the diagrams may represent any one or more of a number of known processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the features and advantages of the invention, but is provided for ease of illustration and description. Although not explicitly illustrated, one of ordinary skill in the art will recognize that one or more of the illustrated steps or functions may be repeatedly performed depending upon the particular processing strategy being used.

Preferably, the control logic is implemented primarily in software executed by a microprocessor-based controller. Of course, some or all of the control logic may be implemented in software, hardware, or a combination of software and hardware depending upon the particular application. When implemented in software, the control logic is preferably provided in a computer-readable storage medium having stored data representing instructions executed by a computer to control the heating/cooling of the vehicle cabin. The computer-readable storage medium or media may be any of a number of known physical devices which utilize electric, magnetic, and/or optical devices to temporarily or persistently store executable instructions and associated calibration information, operating variables, and the like.

While the best mode for carrying out the invention has been described in detail, those familiar with the art to which this invention relates will recognize various alternative designs and embodiments for practicing the invention as defined by the following claims.

What is claimed is:

1. A system for preconditioning a vehicle interior independent of previous climate control settings comprising:
a remote starter;
a climate control head operatively associated with said remote starter, said control head having logic for determining and for responding to climate load demand;
a temperature control door operatively associated with said control head;
an ambient temperature sensor;
an interior temperature sensor; and
a temperature control door position sensor, whereby said control head calculates climate load demand based upon data from said ambient temperature, interior temperature, and control door sensors and preconditions the vehicle in response thereto.

2. The system for preconditioning a vehicle interior of claim 1 wherein said ambient temperature sensor is a Tambient sensor.

3. The system for preconditioning a vehicle interior of claim 1 wherein said interior temperature sensor is a Tcabin sensor.

4. The system for preconditioning a vehicle interior of claim 1 wherein said interior temperature sensor is a Tevaporator thermister.

5. The system for preconditioning a vehicle interior of claim 1 wherein said temperature control door position sensor is a Tset point sensor.

6. The system for preconditioning a vehicle interior of claim 1 wherein said climate control head is part of an electronic automatic temperature control system.

7. The system for preconditioning a vehicle interior of claim 6 further including a sunload sensor also used by the climate controller to calculate climate load.

8. The system for preconditioning a vehicle interior of claim 1 wherein said climate control head is part of a manual temperature control system.

9. The system for preconditioning a vehicle interior of claim 8 wherein said interior temperature sensor is a Tcabin sensor.

10. The system for preconditioning a vehicle interior of claim 1 further including a conditioner for defrosting or defogging vehicle glass operatively associated with said climate control head.

11. The system for preconditioning a vehicle interior of claim 1 further including a conditioner for adjusting the temperature of vehicle seats operatively associated with said climate control head.

12. The system for preconditioning a vehicle interior of claim 1 further including a conditioner for adjusting the temperature of the vehicle steering wheel operatively associated with said climate control head.

13. A system for preconditioning a vehicle interior independent of previous climate control settings comprising:
a remote starter;
a climate control head operatively associated with said remote starter, said control head having logic for determining and for responding to climate load demand based upon input from one or more sensors;
a temperature control door operatively associated with said control head;
a blower operatively associated with said control head; and
an air inlet operatively associated with said control head.

14. The system for preconditioning a vehicle interior of claim 13 wherein said one or more sensors are selected from the group consisting of an ambient temperature sensor, an interior temperature sensor, a temperature control door position sensor, a sunload sensor, a temperature evaporator thermister, and a temperature set point sensor.

15. The system for preconditioning a vehicle interior of claim 13 wherein said climate control head is part of an electronic automatic temperature control system.

16. The system for preconditioning a vehicle interior of claim 13 wherein said climate control head is part of a manual temperature control system.

17. The system for preconditioning a vehicle interior of claim 13 further including a conditioner for defrosting or defogging vehicle glass operatively associated with said climate control head.

18. The system for preconditioning a vehicle interior of claim 13 further including a conditioner for adjusting the temperature of vehicle seats operatively associated with said climate control head.

19. A method of preconditioning a vehicle interior comprising the steps of:
forming a preconditioning system comprising a remote starter, a climate control head operatively associated with said remote starter, said control head having logic for determining and for responding to climate load demand based upon input from one or more sensors, a temperature control door operatively associated with said control head, a Tambient sensor, a Tcabin sensor, and a sunload sensor associated with said control head, and an air inlet operatively associated with said control head;
calculating climate load demand based upon input from said one or more sensors; and
specifying the control head air delivery mode position, said temperature door, the blower speed and the air inlet position in response to the calculated climate load.

20. The method of preconditioning a vehicle interior of claim 19 further including activating and controlling one or more system outputs selected from the group consisting of a blower, an air delivery mode, heated seats, cooled seats, heated steering wheel, air inlet positions, rear window defrost as needed for preconditioning.
